(19) United States
(12) Patent Application Publication
(10) Pub. No.: US 2009/0319198 A1
(43) Pub. Date: Dec. 24, 2009

(54) METHOD AND SYSTEM FOR IDENTIFYING THE FAILURE RISK OF A CONFINEMENT BUILDING

(75) Inventors: Sophie Crouigneau, Paris (FR); Laurent Auge, Paris (FR); Bruno Gerard, Montigny Sur Le Loing (FR); Marc Lasne, Fontainebleau (FR)

Correspondence Address: YOUNG & THOMPSON, 209 Madison Street, Suite 500, Alexandria, VA, 22314, US

(73) Assignee: OXAND, AVON (FR)

(21) Appl. No.: 12/520,666

(22) PCT Filed: Dec. 21, 2007
(86) PCT No.: PCT/FR2007/052617

§ 371 Date: Jun. 22, 2009

(30) Foreign Application Priority Data
Dec. 22, 2006 (FR) 0611330

(51) Int. Cl. G06F 19/00

(52) U.S. Cl. 702/39; 702/35

(57) ABSTRACT

A method for identifying the failure risks of a confinement building, in particular a confinement building made of concrete for stocking or storing a product, includes the following steps: from data concerning the building and/or the product, determining a planned theoretical behaviour of the building during the filling phase of the building with the product to be stored; determining a real behaviour of the building during the filling phase of the building with the product; and determining the failure risks by comparing the theoretical and real behaviours. The method of the invention can also be applied to an emptying phase of the confinement building.

The present invention relates to a method of identifying the risk of failure of a concrete containment or storage structure. It also relates to a system implementing this method.

This invention relates more particularly to a method and a system of identifying the risk of failure of the containment functions of a concrete containment structure, provided for example for the storage or intermediate storage of low and medium level radioactive waste, or liquefied gases.

A major concern of the operators of containment structures such as low and medium level radioactive waste or liquefied gas storage structures, is controlling the risks of degradation, on the one hand of the mechanical properties of the structure by avoiding the failure of the components in the short and long term, and on the other hand of the containment properties by avoiding the deterioration of the components over long periods that can be up to several hundred years.

Existing structure monitoring systems make it possible to evaluate:
the expected theoretical deformations obtained by estimate calculations carried out as a function of data relating to the containment structure; and
the deformations of the containment structure observed during the functional containment phase. These deformations are measured during the storage phase by measuring devices comprising appropriate sensors.
   By functional storage phase of the structure is meant the actual storage phase of the structure, i.e. the phase during which the structure stores a finite volume of the product to be stored. This phase corresponds to the main function of the containment structure, which is the storage of a product, and can be expected to last several hundred years.

It is thus possible to define, with respect to the functional storage phase, a phase of filling the structure with the product to be stored and an evacuation phase (of emptying or partial emptying) of the structure. The filling phase corresponds to the phase during which the containment structure receives the product intended to be stored by this structure and the evacuation phase corresponds to the phase during which the structure is at least partially emptied of the product stored. Of course, the filling phase precedes the functional storage phase and the evacuation phase comes after the functional phase. There can be several filling phases during the life of a containment structure, in particular in the case of the liquefied gas storage structures.

A purpose of the invention is to propose a method and a system of identifying the risks of failure of a containment structure that are more efficient and more comprehensive than the existing methods and systems.

The present invention makes it possible to achieve this purpose through a method of identifying risks of failure of a containment structure, in particular a containment structure essentially made of concrete, intended for storing a product, said method comprising the following stages:
determination, as a function of data relating to said structure and/or said product, of an expected theoretical behaviour of said structure during the phases of filling said structure with said product to be stored;
determination of an actual behaviour of said structure during said phase of filling said structure with said product; and
determination, by comparison of said theoretical and actual behaviours, of the risks of failure of said structure.

Unlike the current methods and systems, the method according to the invention allows for the identification of the risks of failure of a containment structure, and in particular a concrete containment structure, by comparing the theoretical and actual behaviours of this structure during the phase of filling the structure with the product to be stored. In fact, these structures, generally comprising a concrete “foundation raft/shell/closure head” assembly, can be particularly vulnerable during their filling phase, during which their state of stress progressively evolves.

This state can prove to be the most severe in the life cycle of said structure.

Being based essentially on the filling phase of a containment structure, the method according to the invention makes it possible to monitor and provide indicators to help with the decision concerning the filling phase of storage structures in order to preserve their containment functions in the short and long term. By measuring the behaviour of the structure in the filling phase, the method according to the invention makes it possible to:
anticipate possible failures, monitor the risks linked to the behaviour of the structure, and therefore control the operation of the containment structures in order to manage the risks of failure in the short term;
back up the design basis for future structures;
plot the behaviour of the structure during this filling phase, and thus provide a comprehensive dossier that can be consulted throughout the lifetime of the structures for the management of the risks of failure in the long term;

Thus, the method according to the invention makes it possible to control the risks and impacts of this filling phase in the short and long term, by monitoring the behaviour of the components under progressive loading.

Advantageously, the determination of the theoretical behaviour of the structure can comprise at least one simulation of said theoretical behaviour produced by simulation means, such as closed-form resolution or finite element modelling. The simulation takes into account data relating to the structure, dimensions, components and materials and data relating to the product to be stored as well as data relating to the method of filling the structure with the product. The theoretical behaviour of the structure corresponds to the behaviour of the structure expected during a phase of filling the structure with the product to be stored.

The determination of the actual behaviour of the structure can comprise at least one measurement of said actual behaviour carried out on the structure during the filling of said structure with the product to be stored. The actual behaviour of the structure corresponds to the behaviour of the structure while it is being filled with the product to be stored.

Advantageously, the determination of the theoretical and/or actual behaviour of the structure can comprise a determination of at least one deformation of at least one component of said structure during the filling phase. For the determination of the theoretical behaviour, the deformation is determined theoretically, for example by simulation on the basis of data relating to the structure or data relating to a deformation found on a similar structure during its filling phase. Uncertainties regarding the input parameters such as the strength of the materials can be taken into account via a reliability engineering approach. For the determination of the actual behaviour, the deformation is determined by measurements carried out on the structure during the filling phase.

The deformation in question can comprise at least one elastic deformation of at least one component of the structure. In this case, the stage of determination of the actual behaviour of the structure during the filling phase can comprise a measurement of this elastic deformation by sensors appropriately placed on said structure.

The deformation in question can also comprise a deformation by micro-degradation of at least one component of said structure. In this case the stage of determination of the actual behaviour of the structure can comprise at least one acoustic measurement of a deformation by micro-degradation. These measurements are well known to a person skilled in the art.

Micro-degradation is given to mean a micro-fissure or a micro-fracture which can occur at the level of a component of the containment structure, either in the part internal to the material, or in the external visible part.

Advantageously, the method according to the invention can also comprise a stage of proposing a solution for safeguarding said structure as a function of the risks of failure determined. Among the safeguarding solutions mention can be made of:
reinforcing the structure at particular locations;
stopping the filling of the structure at a level determined as a function of the risks of failure;
increasing the monitoring of the structure at particular locations; or
partly or completely stopping operation.

The data relating to the containment structure can comprise:
experimental data relating to the filling phase of a similar structure;
test or simulation data;
data relating to the composition of the structure;
data relating to each of the components of the structure;

Moreover, the method according to the invention can comprise storage, in a database, of information relating to the actual behaviour of the structure during the filling phase. This data can be used subsequently to determine the theoretical behaviour of a similar containment structure during the filling phase while determining the risks of failure of this structure.

In a particular method of utilization, the method according to the invention can be implemented for the identification of the risks of failure of a radioactive waste containment structure, or a liquefied gas storage structure. These containment structures are, most of the time, concrete structures in the form of a “foundation raft/shell/closure head” assembly.

The method according to the invention can advantageously comprise the determination of at least one critical zone of the containment structure. The determination of such a zone can be done by a risk analysis consisting in the determination of at least one failure mode of the structure by analysis of a design and construction dossier of the structure, finite element modelling of the structure as a function of the data relating to the containment structure, and/or by taking into account the data relating to an experiment on a similar or identical structure, i.e. data obtained on a similar or identical containment structure used during a past experiment. The determination of the critical zones makes it possible to concentrate and limit the study of the containment structure to the critical zones. The determination of the theoretical and actual behaviour of the structure during the filling phase can thus be carried out for one or more previously determined critical zones of the structure, which reduces the measurements to be carried out to determine the actual behaviour and the calculations to be carried out to determine the theoretical behaviour.

The term “critical zones” denotes the zones of the containment structure that exhibit a greater probability of failure than the other zones of the structure, and/or the failure of which would lead to more serious consequences from the point of view of safety, the environment or operating losses.

Of course, the method according to the invention can be implemented in order to identify the risks of failure of a containment structure during a plurality of filling phases of said structure.

The method according to the invention can also comprise a determination of the risks of failure of the containment structure during an evacuation phase of the confinement structure. In this case, the theoretical and actual behaviours of the containment structure will be calculated for the evacuation phase of the containment structure. The critical zones of the structure will also be calculated for the evacuation phase of the containment structure. The different stages and operations of the method according to the invention described above for the filling phase of the containment structure, will then be applied in a substantially similar manner to the evacuation phase of the containment structure. The data and the characteristics taken into account in the calculations of the theoretical behaviour will concern the evacuation phase and the actual deformations in order to determine the actual behaviour will be measured during the evacuation phase.

In the case of a non-limitative example of application, the method according to the invention can be applied to containment structures, used in the medium term, such as liquefied natural gas (LNG) storage tanks. The LNG tanks are used as buffer tanks making it possible to regulate the storage of the LNG between its supply by tankers and its gradual distribution to consumers. They are therefore filled or emptied often without there necessarily being an alternation between the filling phases and the evacuation phases. The method according to the invention makes it possible to determine the risks of failure of such a containment structure by carrying out monitoring of this structure relating to filling and evacuation phases.

According to another aspect of the invention a system is proposed of identifying risks of failure of a containment structure, in particular of a containment structure essentially made of concrete, intended for storing a product, said system comprising:
means for determining, as a function of data relating to said structure and/or said product, an expected theoretical behaviour of said structure during a phase of filling said structure with said product to be stored;
means for determining an actual behaviour of said structure during said phase of filling said structure with said product; and
calculation means for determining, by comparison of said theoretical and actual behaviours, the risks of failure of said structure.

The means for determining the actual behaviour of the structure include sensors provided for measuring elastic deformation of at least one component of said structure. These sensors can either be cast in the concrete of the components of a concrete structure (mounting supported on the reinforcements if reinforced concrete), or be accessibly mounted on the external surfaces of the components of the structure in order to guarantee their maintenance throughout the lifetime of the structures. This choice of sensors may for example depend on the presence or absence of organic matter in the sensors. In a particular embodiment these sensors can comprise sensors of an optical fibre, creep meter or clinometer type.

The means for determining the actual behaviour of the structure can also comprise sensors provided for measuring deformation by micro-degradation of at least one component of said structure. In a particular embodiment these means can comprise for example acoustic sensors appropriately placed in order to determine deformation by micro-degradation of a component of the structure. In fact, micro-degradation can, above a certain level, produce an acoustic signal that can be measured by acoustic sensors. By using several acoustic sensors it is possible to determine the location of the micro-degradation by triangulation, for example.

Other advantages and characteristics of the invention will become apparent on examination of the detailed description of an embodiment which is in no way limitative, and the attached diagrams, in which:

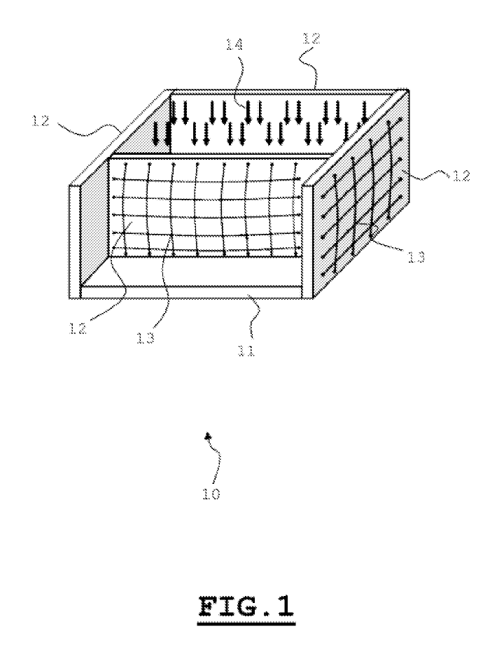

FIG. 1 is a diagrammatic representation of a containment structure;

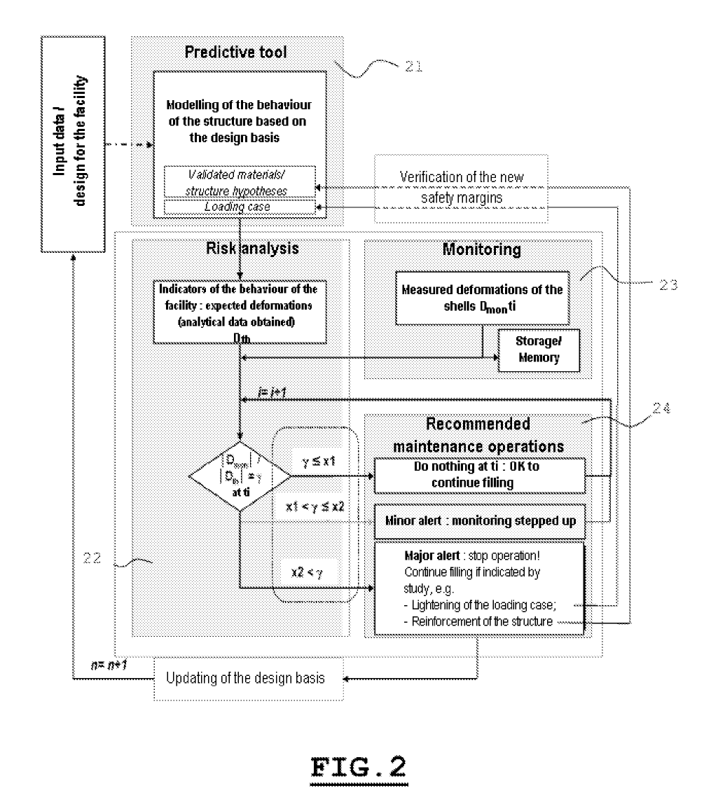

FIG. 2 is a flowchart showing the principle of determination of the risks of failure of a containment structure according to the method according to the invention;

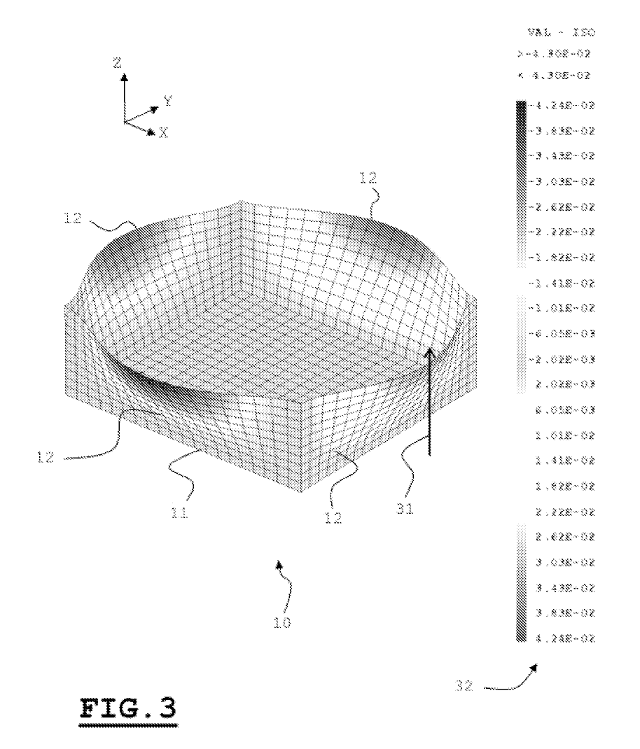

FIG. 3 is a representation of the deformations of a containment structure during the filling phase of this structure;

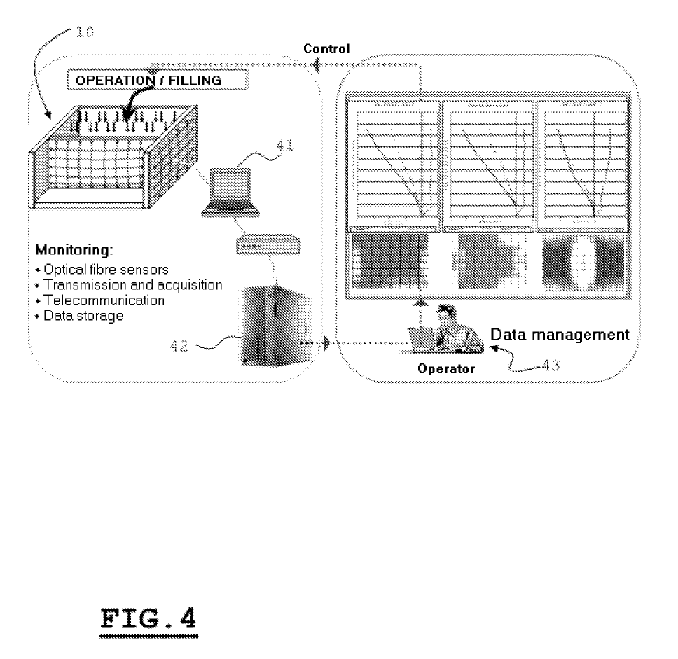

FIG. 4 is a diagrammatic representation of a system of determining of the risks of failure of a containment structure by means of the method according to the invention;

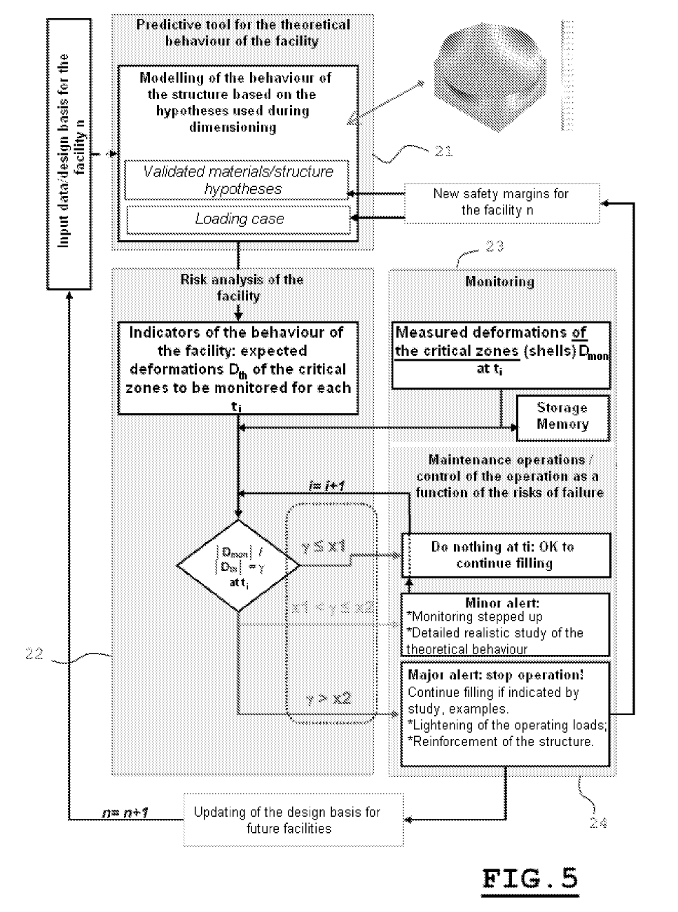

FIG. 5 is a representation of the flowchart in FIG. 2, in which the determination of the risks of failure is limited to critical zones; and

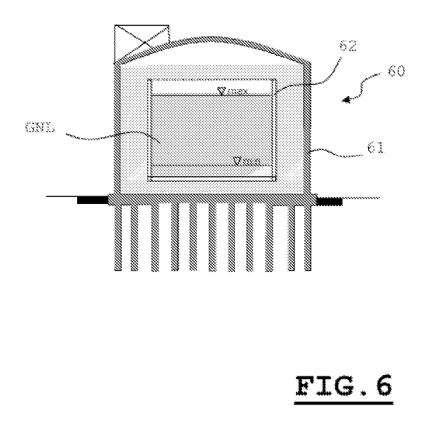

FIG. 6 is a diagrammatic representation of a liquefied natural gas (LNG) storage tank.

FIG. 1 is a representation of a confinement structure 10 for low or medium level radioactive waste. The containment structure 10 is in the form of a parallelepipedic tank made of reinforced concrete comprising a foundation raft 11, and shells 12.

This radioactive waste storage structure 10 is equipped with sensors 13 which are either cast in the concrete of the components and in particular of the shells 12 by a mounting supported on the reinforcements, or mounted on the external surfaces of the shells 12 with a view to removal once filling is completed. This choice depends on the presence or absence of organic matter in the sensors. In the present example, the sensors 13 are composed of sensors of an optical fibre or inclinometer type provided for measuring the deformations of the shells during the filling of the tank 10 as well as acoustic sensors provided for measuring the deformations by micro-degradation: micro-fissures or micro-fractures. The tank 10 is filled in the direction of the arrows 14 shown in FIG. 1.

FIG. 2 shows a flowchart showing the principle of determination of the risks of failure of the containment structure 10 according to the method according to the invention. As a function of the input data relating to the tank 10, to the product to be stored as well as to the method of filling the tank 10 and the design basis, a predictive tool 21 makes it possible to analytically model the theoretical behaviour of the tank 10 and to provide indicators relating to this behaviour during the filling phase. Among these indicators are indicators relating to the expected theoretical deformations Dₜₕ on the tank 10. These indicators are communicated to a module 22 for analysis and determination of the risks of failure.

This tank is filled with a heterogeneous, radioactive fluid, of variable density, in several stages. During the filling phase a monitoring unit 23 provides the actual deformations Dₘₒₙ measured by means of the sensors 13 placed on the tank 10. These deformations Dₘₒₙ are, on the one hand recorded for subsequent use during the modelling of the theoretical deformations of another containment structure similar to the tank 10, and on the other hand sent to the module 22 for analysis and determination of the risks of failure.

The unit 22 then determines, by comparison of the theoretical deformations Dₜₕ calculated by the predictive tool 21 and the deformations Dₘₒₙ measured during the monitoring of the filling phase by the module 23, the risks of failure of the tank 10. As a function of these risks, a unit 24 proposes solutions for safeguarding the tank 10 as a function of the determined risks of failure.

We are interested in our example in the deformation undergone by a shell 12 of the tank 10, on its central axis represented by the arrow 31 in FIG. 3, throughout the filling phase. FIG. 3 is a representation of the modelling of the deformation of the shells 12 of this tank 10 according to the regulatory design basis. This modelling, carried out by the predictive tool 21, makes it possible to obtain the theoretical deformations Dₜₕ that can be predicted for each of the shells 12 for a set filling height. The theoretical deformations of the shells 12 are determined with respect to an axis 32 represented in this FIG. 3. At time tᵢ, the filling height hᵢ has been set: a very specific state of deformation of the shells 12, predetermined by the results of the modelling, corresponds to this height hᵢ. Several models are produced, for a relevant number of hᵢ, as a function of the total height of the shells 12. Thus, at time tᵢ, all of the theoretical displacements D_{th(hl, z)} of the shell 12 along the axis z are obtained. The table below gives the theoretical deformations D_{th(hl, z)} expected for the shells 12 of the tank 10 as a function of the filling height:

| Regulatory theoretical displacements | | | | | | | | |
|---|---|---|---|---|---|---|---|---|
| D_{th(hi, z)} expected along the shell at time | | hᵢ: filling height at time tᵢ [m] | | | | | | |
| tᵢ (results of the models, along Ox) | | 0.2 | 0.4 | 0.6 | 0.8 | 1 | 1.2 | . . . |
| ordinate of the shell z [m] | 0 | 0.0 | 0.0 | 0.0 | 0.0 | 0.0 | 0.0 | . . . |
| | 0.2 | 0.3 | 0.4 | 0.5 | 0.5 | 0.5 | 0.6 | . . . |
| | 0.4 | 0.2 | 0.5 | 0.6 | 0.6 | 0.7 | 0.7 | . . . |
| | 0.6 | 0.1 | 0.4 | 0.5 | 0.6 | 0.7 | 0.8 | . . . |
| | 0.8 | 0.0 | 0.2 | 0.3 | 0.5 | 0.7 | 0.8 | . . . |
| | 1 | 0.0 | 0.1 | 0.2 | 0.3 | 0.5 | 0.9 | . . . |
| | 1.2 | 0.0 | 0.0 | 0.1 | 0.2 | 0.4 | 1.0 | . . . |
| | 1.4 | 0.0 | 0.0 | 0.0 | 0.2 | 0.3 | 0.8 | . . . |
| | 1.6 | 0.0 | 0.0 | 0.0 | 0.0 | 0.2 | 0.3 | . . . |
| | 1.8 | 0.0 | 0.0 | 0.0 | 0.0 | 0.1 | 0.1 | . . . |
| | 2 | 0.0 | 0.0 | 0.0 | 0.0 | 0.0 | 0.0 | . . . |
| | . . . | . . . | . . . | . . . | . . . | . . . | . . . | . . . |

These theoretical deformations D_{th(hl, z)} obtained by the predictive tool 21 by analytical simulation are supplied to the module 22 for analysis and determination of the risks of failure.

Moreover, at each time tᵢ corresponding to the setting of a filling height hᵢ, entry of the data from the sensors 13 is entered into and saved by the monitoring module 23. The actual displacements D_{mon(hl, z)} along the central axis 31 of the shells 12 are thus obtained. These deformations D_{mon(hl, z)} are supplied to the module 22 for analysis and determination of the risks of failure.

The module 22 for analysis and determination of the risks of failure thus receives:
the theoretical deformations D_{th(hl, z)} obtained by the predictive tool 21 by analytical simulation; and
the actual deformations D_{mon(hl, z)}, obtained by the monitoring module 23 by means of the sensors 13.
   At each time tᵢ the theoretical D_{th(hl, z)} and actual D_{mon(hl, z)} deformations are compared. The theoretical state of deformation of the shell is thus compared with its actual state of deformation: in concrete terms, for each ordinate z, D_{th(hl, z)} and D_{mon(hl, z)} are compared.

The risks of failure of the shells 12, calculated by the module 22, are directly linked to the differences between D_{th(hl, z)} and D_{mon(hl, z)}. By way of example, it is possible to define 3 levels of risk, linked to three levels of difference, and the safeguarding solutions recommended for each level of risk:

| Difference \|Dmon(hi, z)\|/ | | |
|---|---|---|
| \|Dth(hi, z)\| = γ | Risk level | Decision recommended to the operator |
| if γ ≧ 0.6 | Low risk | Nothing to report: filling can be continued normally |
| if 0.6 < γ ≦ 0.8 | Moderate risk | Minor alert: monitoring of the deformations must be |
| | | stepped up |
| if γ > 0.8 | High risk | Major alert: filling must be suspended; resumption of the |
| | | filling must be demonstrably justified (e.g. exploitation of |
| | | the passive reinforcements' capacity for plastic |
| | | adaptation, or proposal to reinforce the structure) |

As shown in FIG. 4, the operator 41, using this approach, thus has indicators to help with the decision allowing for control of the risks of filling a containment structure 10 and of the risks of failure of the structure linked to the behaviour of the structure during the filling phase. He has calculation means 42 provided to determine by simulation the theoretical behaviour of the structure during a filling phase, monitoring means provided to determine the actual behaviour of the structure 10 during the filling phase and calculation means 43 provided to determine the risks of failure as well as means of proposing a safeguard solution for each level of risk detected.

FIG. 5 is a representation of the flowchart of FIG. 2, in which the determination of the failure risks of the containment structure is concentrated on previously determined critical zones. As indicated, the expected deformations are calculated by the predictive tool 21 only for the critical zones and the actual deformations are measured at the level of the critical zones by the monitoring module 23 by means of the sensors 13.

The determination of the critical zones of the structure is carried out via a risk analysis of the different components of the structure. This risk analysis determines and pinpoints the most critical failure modes of the structure: it may be based on a study of the design dossier of the structure, for example a study of the safety margins provided in the design, and/or on a study of the construction dossier of the structure which may reveal initial defects, defective work, deviations in construction with respect to the design of the structure, and/or by the taking into account of data relating to an experiment on a similar or identical structure, i.e. data obtained on a similar or identical containment structure used during a past experiment, and/or by finite element modelling of the structure.

The determination of the critical zones can be carried out in parallel with the determination of the theoretical behaviour of the structure, or beforehand.

The method according to the invention can be applied to any concrete containment structure and in particular to liquefied natural gas (LNG) storage tanks. FIG. 6 is a diagrammatic representation of a total integrity LNG storage tank 60. Such a tank 60 is made up of a concrete containment structure 61 and an internal container 62 holding the LNG. The concrete containment structure 61 has the functions of avoiding:
the discharge of liquid LNG into the environment in the event of a rupture of the internal container, and
leakages of LNG vapour into the atmosphere.

Such a containment structure 61 is a “buffer” structure, i.e. it makes it possible to regulate the storage of the LNG between its supply by tankers and its gradual distribution to consumers. Its operating life is generally several decades (approximately 40 to 60 years).

The internal container 62 of the tank 60 is subjected to irregular filling and partial emptying or evacuation phases as a function of the rhythm of supply and demand for distribution. As a function of the filling of the internal container, the load on the different components of the external enclosure varies: indirectly via the foundation raft in the case of self-supporting structures, directly on the shells and the foundation raft in the case of membrane-lined structures.

The method according to the invention makes it possible to determine the risks of failure of such an LNG tank by monitoring the structure during each tank filling phase and, optionally, during each tank evacuation phase.

Of course, the invention is not limited to the examples which have just been described and numerous adjustments can be made to these examples without exceeding the scope of the invention.

1. Method of identifying the risks of failure of a containment structure (10), in particular a containment structure essentially made of concrete, intended for the storage or intermediate storage of a product, said method comprising the following stages:
determination, as a function of data relating to said structure (10) and/or said product, of an expected theoretical behaviour of said structure (10) during a phase of filling said structure (10) with said product to be stored;
determination of an actual behaviour of said structure (10) during said phase of filling said structure (10) with said product; and
determination, by comparison of said theoretical and actual behaviours, of the risks of failure of said structure (10).

2. Method according to claim 1, characterized in that it comprises determination of at least one critical zone of the structure by study of a design and/or construction dossier of the structure, and/or of data relating to an experiment on a similar or identical structure.

3. Method according to claim 2, characterized in that the determination of the theoretical and actual behaviour of the structure (10) during the filling phase is carried out for one or more previously determined critical zones of the structure.

4. Method according to claim 1, characterized in that the determination of the theoretical behaviour of the structure (10) comprises at least one simulation of said theoretical behaviour carried out in simulation means (21).

5. Method according to claim 1, characterized in that the determination of the actual behaviour of the structure (10) comprises at least one measurement of said actual behaviour carried out on said structure (10) during the filling of said structure (10) with the product to be stored.

6. Method according to claim 1, characterized in that the determination of the theoretical and/or actual behaviour of the structure (10) comprises determination of at least one deformation (Dₜₕ, Dₘₒₙ) of at least one component (12) of said structure (10) during the filling phase.

7. Method according to claim 6, characterized in that the deformation comprises at least one elastic deformation of at least one component (12) of the structure (10).

8. Method according to claim 7, characterized in that the stage of determination of the actual behaviour of the structure (10) comprises a measurement of an elastic deformation by sensors (13) appropriately placed on said structure (10).

9. Method according to claim 6, characterized in that the deformation comprises deformation by micro-degradation of at least one component (12) of said structure (10).

10. Method according to claim 9, characterized in that the stage of determination of the actual behaviour of the structure (10) comprises at least one acoustic measurement of deformation by micro-degradation.

11. Method according to claim 1, characterized in that it also comprises a stage of proposing a solution for safeguarding said structure (10) as a function of the determined risks of failure.

12. Method according to claim 1, characterized in that the data relating to said structure (10) includes experimental data relating to the filling phase of a similar structure.

13. Method according to claim 1, characterized in that it comprises storage, in a database, of information relating to the actual behaviour of the structure (10) during the filling phase.

14. Method according to claim 1, characterized in that it is implemented in order to determine the risks of failure of a containment structure during a plurality of filling phases of said structure.

15. Method according to claim 1, characterized in that it is implemented in order to identify the risks of failure of a radioactive waste confinement structure (10).

16. Method according to claim 1, characterized in that it is implemented in order to identify the risks of failure of a total integrity liquefied natural gas (LNG) storage tank (60).

17. Method according to claim 1, characterized in that it also comprises determination of the risks of failure during an evacuation phase of the containment structure, the different operations and stages of said method being reiterated during said evacuation phase.

18. System of identifying the risks of failure of a containment structure, in particular a containment structure (10) essentially made of concrete, intended for storing a product, said system comprising:
means (21) of determining, as a function of data relating to said structure (10) and/or said product, a theoretical behaviour of said structure (10) during a phase of filling said structure (10) with said product to be stored;
means (23) of determining an actual behaviour of said structure (10) during said phase of filling said structure (10) with said product; and
calculation means (22) of determining, by comparison of said theoretical and actual behaviours, the risks of failure of said structure (10).

19. System according to claim 18, characterized in that the means (23) of determining the actual behaviour of the structure (10) include sensors (13) provided for measuring an elastic deformation of at least one component (12) of said structure (10).

20. System according to claim 19, characterized in that the sensors (13) provided for measuring elastic deformation include optical fibre or clinometer type sensors.

21. System according to claim 18, characterized in that the means (23) of determining the actual behaviour of the structure (10) include sensors (13) provided for measuring deformation by micro-degradation of at least one component (12) of said structure (10).

22. System according to claim 21, characterized in that the sensors (13) provided for measuring deformation by micro-degradation include acoustic sensors.
